(19) United States
(12) Patent Application Publication
(10) Pub. No.: US 2010/0059450 A1
(43) Pub. Date: Mar. 11, 2010

(54) METHOD FOR PROCESSING FATTY WASTES

(75) Inventors: Laurence LAFOSSE, Carrieres Sous Poissy (FR); Olivier BELLYNCK, Yvry Sur Seine (FR); Vincent GEORGEAUD, Poigny La Foret (FR); Fabrice LEFEBVRE, Gouvieux (FR); Tristan ROBINO, Thiers Sur Theve (FR)

Correspondence Address: HARNESS, DICKEY & PIERCE, P.L.C., P.O. BOX 828, BLOOMFIELD HILLS, MI, 48303, US

(73) Assignee: VEOLIA PROPRETE, Nanterre (FR)

(21) Appl. No.: 12/552,537

(22) Filed: Sep. 2, 2009

(30) Foreign Application Priority Data
Sep. 5, 2008 (FR) 0855975

(51) Int. Cl. C02F 1/52; C02F 103/32; C02F 103/34

(52) U.S. Cl. 210/708

(57) ABSTRACT

The invention relates to a method for processing fatty wastes leading to a better valorization, particularly for use as fuel.

According to the invention, this method is substantially characterized in that it comprises a chemical treatment of fatty wastes (1, 1′), wherein fatty wastes (1, 1′) are mixed with water (8) and an acid-type reagent (7) so as to obtain a demineralized fatty phase not containing mineral elements belonging to the alkaline and alkaline earths families, and an aqueous phase which may include solid residues as precipitates; followed by a mechanical treatment wherein the obtained mixture undergoes a mechanical separation (11) through decanting or filtering, so as to separate the demineralized fatty phase from the aqueous phase.

### FIELD

The present invention generally relates to the field of waste processing, particularly for their use as fuel.

More specifically, the invention concerns a method for processing fatty wastes, particularly for their use as fuel.

More particularly, the invention is applicable to fatty wastes originating from agri-food or cosmetic industries, notably from their decanting facilities, or originating from restaurants and food-preparing facilities as well as from municipal or industrial wastewater pretreatment facilities such as skimming tanks and degreasers, or further from knackeries.

### SUMMARY

These fatty wastes are mainly composed of a fatty fraction, an aqueous fraction as well as a residual fraction.

The fatty wastes dealt with by the invention, and having an heterogeneous composition, may be solid and/or liquid and may be composed of plural types of vegetable oils and/or animal fat.

The invention is particularly applicable to the fatty fraction, which may contain at least 90% of organic matter on a dry basis but also up to 100% ash on a dry basis.

The ashes correspond to the mineral matters contained within a fatty waste sample, and more particularly to the mineral elements which, according to Mendeleïev's periodic table of chemical elements, belong to the alkaline family (Li, Na, K, Rb, Cs, Fr) and/or to that of alkaline earths (Be, Mg, Ca, Sr, Ba, Ra).

This fatty fraction has a high calorific value making it possible to use it for energy purposes. Its net calorific value, or NCV, may be comprised between 33.494 10⁶ and 37.681 10⁶ joules/kg (that is, between 8000 and 9000 kcal/kg).

Nevertheless, use for energy purposes is limited because of the high rate of mineral matters contained in the fatty fraction.

For instance, burner manufacturers recommend a maximum mineral matter rate of 0.03 wt %, or even 0.01 wt %, in the case of cogeneration engines, whereas the fatty fraction, concerned by the present invention, may contain up to 10 wt % of mineral matters on a dry basis.

Presently, the burning of a fatty fraction within a boiler leads to important fouling as well to strong refuse of dusts in fumes. Its combustion within vehicular or cogeneration engines, would lead to mechanical malfunctioning.

Accordingly, the valorization alternative of this fatty fraction is merely reduced, today, to its use in industrial furnaces or cement plant furnaces.

In this regard, the aim of the present invention is to propose a method for the processing of fatty waste exempt from at least one of the aforementioned restrictions and particularly allowing improving the valorization of these wastes.

To this end, the invention relates to a method for processing fatty wastes, characterized in that it comprises a chemical treatment of the fatty wastes, wherein fatty wastes are mixed with water and an acid-type reagent, to obtain a demineralized fatty phase as well as an aqueous phase which may include solid residues in the form of precipitates; followed by a mechanical treatment during which the obtained mixture undergoes a decanting or filtering mechanical separation, in order to separate the demineralized fatty phase from the aqueous phase.

Thus, the demineralized fatty phase according to the invention does not contain mineral elements pertaining to the alkaline and/or alkaline earths families.

The demineralization of fatty wastes through chemical treatment corresponds to the disposal of mineral elements belonging, in Mendeleïev's periodic table of chemical elements, to the alkaline family (Li, Na, K, Rb, Cs, Fr) and/or to that of alkaline earths (Be, Mg, Ca, Sr, Ba, Ra).

The analysis of the mineral matter rate indicates the performance of the demineralization reaction. This analysis consists in carrying out a complete combustion, or calcination, at a temperature in the range of 550° C. to 815° C. depending on the applied standards, for instance at 550° C. for biomass, at 775° C. for petroleum products bases on NF EN ISO 6245, or at 815° C. for coal according to NF M 03-003.

According to an advantageous form of the invention, the fatty wastes originate from agri-food or cosmetic industries, and particularly from the decanting facilities thereof, or from restaurants and food preparing facilities, or municipal or industrial wastewater pre-treatment facilities, such as skimming tanks and degreasers, or knackeries.

Fatty wastes may be mainly composed of a fatty fraction, an aqueous fraction as well as a residual fraction, and be processed, prior to the method of the invention, to hold only the fatty fraction containing at least 90%, and preferably between 90 and 99%, of organic matter on a dry basis and at most 10%, and preferably between 1 to 10%, of ash on a dry basis.

The organic matter or ash content, on a dry basis, corresponds to the organic matter or ash content, of fatty waste solids, that is, a fatty waste extract free from water.

More specifically, the mechanical separation of the method according to the invention may be carried out through gravitational or accelerated decanting, or further through pressurized or non pressurized hot surface filtering, and for example with a mesh between 20 microns and 1 mm, or preferably between 50 microns and 1 mm.

Preferably, the fatty wastes, water and acid-type reagent are mixed at a temperature comprised between 45 and 130° C.

Advantageously, the fatty waste, water and acid-type reagent are mixed through stirring, so as to homogenize the mixture.

For example, the amount of water mixed to fatty wastes is comprised between 1/10 and ½ of the fatty waste volume, and is preferably of about ¼ of this volume.

Preferably, prior to mixing it to the fatty wastes, water is at room temperature or at a temperature comprised between 30 and 100° C., most preferably between 50 and 70° C.

Demineralized or drinking or clean process water may be used. What is meant by “process water” is water used in an industrial facility for operating a process or manufacturing a product.

According to a preferred embodiment of the invention, the acid-type reagent amount mixed to the fatty wastes is comprised between 0.5 and 10% of fatty waste volume, and preferably between 0.5 and 4%.

Advantageously, the acid-type reagent amount mixed to the fatty wastes is proportional to the rate of ash contained in these wastes.

The acid-type reagent mixed to the fatty wastes is advantageously composed of at least an acid selected from the group consisting of mineral acids, such as those of the formula HCl, H₃PO₄, HNO₃ or H₂SO₄, and organic acids of which pKa is less than the pH of fatty wastes in an aqueous medium, for example formic acid HCOOH for fatty wastes of which the pH is about 4.5 in an aqueous medium.

According to a particular form of the invention, the chemical treatment of the fatty wastes mainly consists in that these fatty wastes are first mixed to a small amount of water, between 10 and 30% of the total amount of water to be mixed to fatty wastes, this mixture being homogenized and heated to a temperature comprised between 45 and 130° C., then, the balance of the total amount of water to be mixed to fatty wastes and to the acid-type reagent are added simultaneously to said mixture.

Preferably, the fatty wastes are mixed with water and the acid-type reagent for a reaction period comprised between 5 minutes and 3 hours, and more preferably for a reaction period of about 45 minutes, under permanent or intermittent stirring.

The method according to the invention may further comprise, prior to the mixing of fatty wastes to water and to the acid-type reagent, a first fatty waste filtering operation intended to remove any impurity.

For example, this first filtering operation is a pressurized surface filtering carried out with a mesh comprised between 20 microns and 1 mm, or preferably between 50 microns and 1 mm, or most preferably of about 250 microns.

Following the mechanical treatment, a second filtering operation of the demineralized fatty phase may also be carried out.

This second filtering operation is preferably a pressurized or non-pressurized hot surface-type filtering operation, carried out with a mesh of between 20 microns and 1 mm, or preferably between 50 microns and 1 mm.

Advantageously, the mixture obtained following the chemical treatment is heated to undergo the mechanical treatment.

The demineralized fatty phase, obtained after the fatty waste chemical treatment and then the mechanical treatment, may thus be subjected to a valorization process.

According to a particular form of the invention, the demineralized fatty phase, obtained after the fatty waste chemical treatment and then the mechanical treatment, and prior to its valorization, is stored and heated, possible residues which have decanted during storage being removed from said demineralized fatty phase.

Thus, the method according to the invention makes it possible to remove the mineral matter from fatty waste, so as to use them for energy purposes in any valorization alternative whatsoever, and whatever their origin is.

The method for processing fatty wastes, and more specifically the fatty fractions, according to the invention makes it possible to remove the mineral matters belonging to the alkaline and/or alkaline earths families and to obtain an ash rate less than 0.1 wt %, or less than 0.03 wt %.

This mineral matter rate reduction makes it possible to particularly valorize the fatty wastes and/or the fatty fraction on the production site, in the form of boiler fuel for example, which lowers the transport related costs, and thus, carbon dioxide emissions compared to the situation in which the fatty wastes and/or the fatty fraction were transported to cement plants or industrial furnaces on relatively long distances from the production site.

On the other hand, this reduction of the mineral matter rate makes it possible to use demineralized fatty wastes in lieu of more pollutants, less environmental-friendly fuels such as fuel oil, in new applications, such as urban or industrial boilers, cogeneration engines, vehicular engines, after they being transformed into biofuel.

Moreover, the use of fatty wastes as fuel after their processing according to the method of the invention has the advantage of emitting smokes not requiring additional treatments prior to their release to atmosphere, and also to avoid the fouling of combustion facilities.

### DRAWING DESCRIPTION

Other features and advantages of the invention will become more apparent upon reading the following detailed description thereof which is given by way of a non limitative example, with reference to the accompanying drawing.

FIG. 1 is a schematic view of an installation adapted for the implementation of the method according to the invention.

### DETAILED DESCRIPTION

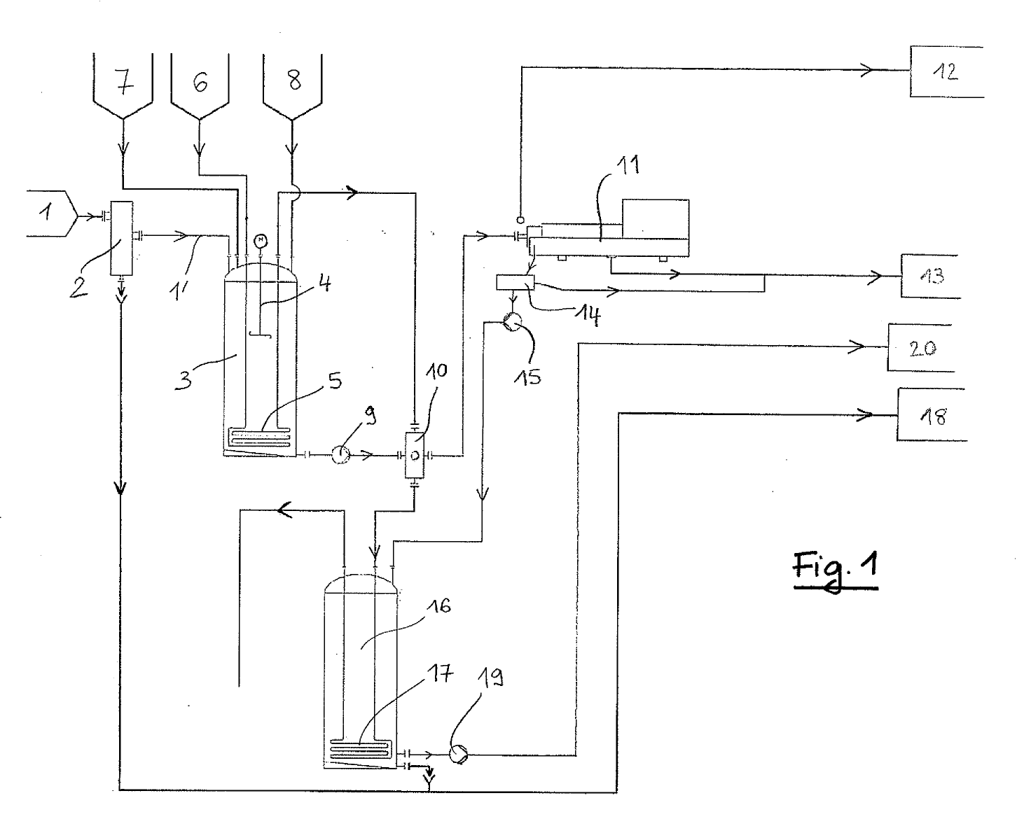

Fatty wastes 1 to be processed, and more preferably the fatty fraction of these fatty wastes from which the aqueous fraction as well as a residual fraction have been removed beforehand (not shown), are provided to the installation of FIG. 1.

Fatty wastes 1 are first filtered in a first filter 2 so as to remove as much impurities as possible.

This filtering may be a pressurized surface filtering carried out with a mesh of between 20 microns and 1 mm, or preferably between 50 microns and 1 mm, and more preferably a mesh of about 250 microns.

Then, the filtered fatty wastes 1′ are provided to a reaction tank 3 so as to undertake a chemical treatment.

This tank 3 is preferably provided with a stirrer 4, a heating member such as a heater tube 5 immersed into tank 3 and supplied with hot water 6, as well as a level sensor. This tank is advantageously insulated.

Water 8 and acid-type reagent 7 are added in this reaction tank 3.

The reagents introduced in tank 3 form a mixture which is homogenized with stirrer 4.

The stirring operation, consisting in a miscible liquid-liquid mixture, is preferably carried out with an axial flowrate mobile element.

Stirrer 4 may operate on a pumping mode.

The hydrodynamic load in tank 3 is preferably of a low shearing type.

Reaction tank 3 is heated by means of heater tube 5 which induces a tank temperature comprised between 45 and 130° C., and preferably between 50 and 90° C.

The total amount of water 8 to be added into tank 3 is comprised between 1/10 and ½ of the fatty waste 1 or 1′ volume, and preferably of about ¼ of this volume.

Water 8 in tank 3 may be hot or at room temperature, that is, at a temperature comprised between 30 and 100° C., or preferably between 50 and 70° C. For example, water 8 is preferably heated by means of a boiler.

The added water may be demineralized water, drinking water or clean process water.

The amount of acid-type reagent 7 to be added into tank 3 is comprised between 0.5 and 10% of the fatty waste 1 or 1′ volume, that is, between 0.07 and 1.5H⁺ Equivalent per liter of fatty wastes including up to 10% ash on a dry basis and between 90 and 99% of organic matter on a dry basis. Preferably, this amount is comprised between 0.5 and 4% of fatty waste volume, that is, between 0.07 and 0.6H⁺ Equivalent per liter of fatty wastes.

To allow for the reduction of mineral matter in fatty wastes according to the invention, the added acid-type reagent 7 may be a mineral acid such as hydrochloric acid HCl, phosphoric acid H₃PO₄, nitric acid HNO₃, and sulfuric acid H₂SO₄, or an organic acid of which pKa is low enough and less than the pH of fatty wastes in an aqueous medium, for instance formic acid HCOOH, of which pKa is of 3.75, or a combination of these acids.

Besides the mineral matter reduction rate, the following criteria could be considered for the selection of the acid-type reagent: availability in industrial quantities, no breakdown of fatty waste fats by the reagent, the reagent boiling temperature should be suitable and specifically higher than 100° C., absence of harmful releases during chemical treatment, and no corrosion of tank 3 material by the reagent.

For example, when tank 3 is made of stainless steel, phosphoric acid is preferred as it does not corrode the tank walls.

The reagents, that is, fatty wastes 1′, or more particularly the fatty fraction, water 8 and the acid-type reagent 7, may be injected into reaction tank 3 according to various sequences.

Preferably, fatty wastes 1′, or the fatty fraction, are first provided to tank 3. Then, a small amount of water 8 is added so as to promote the contact between the reagents into tank 3. For example, this small amount is comprised between 10% and 30% out of the total amount of water 8 to be introduced into tank 3.

This first mixture is homogenized and heated till it reaches a temperature ideal for the chemical treatment, comprised between 45 and 130° C.

Then, the remaining amount of water 8 out of the total volume of water 8 to be added, as well as the acid-type reagent 7 are simultaneously injected to the first mixture so as to obtain a second mixture.

The chemical treatment inside tank 3 advantageously lasts for 5 minutes to 3 hours, under permanent or intermittent homogenization. Preferably, the reaction into tank 3 is carried out for 45 minutes.

After reacting into tank 3, the second mixture is transferred, by means of a pump 9, towards a heat exchanger 10, which may be of a plate, coil or spiral type.

The aim of transferring this mixture into heat exchanger 10 is to rise its temperature prior to it being subjected to the mechanical treatment so as it remains in a sufficiently liquid state during this treatment.

Preferably, the mixture is brought to a temperature of at least 80° C. before the mechanical treatment.

Then, by means of pump 9, the reaction mixture reaches a mechanical separation means, such as a centrifuge device 11.

The aim of this mechanical separation is to separate the fatty phase demineralized during the chemical treatment from an aqueous phase as well as from precipitated residues.

This separation may be implemented through accelerated decanting by means of a two- or three-phase centrifuge device or wringer, or through gravitational decanting in a single tank or in a complex or single settler, or through pressurized or non-pressurized hot surface filtering with a mesh comprised between 20 microns and 1 mm, or preferably between 50 microns and 1 mm.

The aqueous phase 12 and precipitated residues 13 are then processed or removed using the best alternative according to their respective characteristics.

At the exit of centrifuge device 11, the fatty phase accordingly purified is passed through a second filter 14. The filtering thus carried out may be a pressurized or non-pressurized hot surface filtering with a mesh comprised between 20 microns and 1 mm, or preferably between 50 microns and 1 mm.

Through a pump 15, the fatty phase, purified and filtered could then be sent to a storage tank 16, similar to reaction tank 3, heated by means of a tub 17 similar to that arranged in tank 3 but not provided with a stirring device.

The possible residues 18 settled on bottom of storage tank 16 are removed, for example, by means of the same alternative as for those solid residues obtained from first filter 2.

The purified and stored fatty phase may be supplied, by means of a pump 19, to a valorization facility 20.

For example, pumps 9, 15 and 19 are rotational or alternative type displacement pumps.

Otherwise, the fatty phase may be conveyed to a valorization facility (not shown) at the exit of centrifuge device 11, or at the exit of second filter 14.

### Example 1

In this example, the method according to the invention is carried out with a mechanical treatment either through gravitational decanting or accelerated decanting, or centrifugation.

The tests carried out as well as the obtained results are summarized in table 1.

Various samples of fatty fraction have been chemically treated with an acid-type reagent volumetric ratio of 1.6% then separated through gravitational decanting for 24 hours or through accelerated decanting.

TABLE 1

| | Initial characteristics | | Final characteristics of | | |
|---|---|---|---|---|---|
| | of fatty fraction | | processed fatty fraction | | |
| | Mean | Mean | Mean | Mean | Mean |
| | raw DM | raw MM | yield | DM | MM |
| Gravitational | 95.85% | 1.75% | 75.45% | 97.87% | 0.09% |
| decanting | | | | | |
| Accelerated | 95.28% | 1.70% | 92.02% | 97.57% | 0.04% |
| decanting | | | | | |

DM = dry matter; MM = mineral matter

In both decanting modes, the amount of mineral matters in the fatty fraction samples is divided by more than a half.

As far as fatty fractions with quasi identical initial characteristics are concerned, the mean yield of the operation is better with the accelerated decanting mode than that with the gravitational decanting mode.

### Example 2

In this example, the method according to the invention is carried out with a chemical treatment implemented through various reagents adding sequences, then, by accelerated decanting-based mechanical treatment.

Table 2 summarizes the obtained results for various fatty fraction samples processed according to four different injection sequences:

Sequence 1: introducing the fatty fraction then simultaneously the water/acid-type reagent mixture;

Sequence 2: introducing the fatty fraction then water, then the acid-type reagent;

Sequence 3: introducing the water/acid-type reagent mixture then the fatty fraction;

Sequence 4: introducing the fatty fraction then a portion of water (between 10 and 30% of the total amount of water to be injected), then simultaneously, adding the balance of water as well as the acid-type reagent.

TABLE 2

| | Initial characteristics | | Final characteristics of | | | |
|---|---|---|---|---|---|---|
| | of fatty fraction | | processed fatty fraction | | | |
| | Mean | Mean | Mean | Mean | Mean | Mean MM |
| | raw DM | raw MM | yield | DM | MM | reduction |
| Seq. 1 | 96.34% | 1.49% | 93.30% | 96.62% | 0.09% | 92.87% |
| Seq. 2 | 94.64% | 1.77% | 89.66% | 97.27% | 0.04% | 97.69% |
| Seq. 3 | 94.74% | 1.79% | 85.64% | 97.16% | 0.12% | 93.47% |
| Seq. 4 | 95.85% | 1.75% | 93.14% | 98.62% | 0.02% | 98.47% |

DM = dry matter; MM = mineral matter

Whatever the injection sequence is, the fatty fraction mineral matter is removed, with a high reaction yield (>85%) and the target ash rate 0.1% on a dry basis) reached.

For fatty fraction samples of close quality, injection sequence 4 operates best. In fact, it exhibits the best mean yield/mean MM ratio.

These injection sequences are not exhaustive. Specifically, as for water in sequence 4, the injection of the acid-type reagent may be done in two times.

The method according to the invention may be used in the field of fatty waste processing in order to use them as fuel, or in the field of lipid chemistry.

1. A method for processing fatty wastes, characterized in that it comprises:
a chemical treatment of the fatty wastes, wherein fatty wastes are mixed with water and to an acid-type reagent, so as to obtain a demineralized fatty phase not containing mineral elements belonging to the alkaline and alkaline earths families, as well an aqueous phase which may include solid residues as precipitates;
followed by a mechanical treatment wherein the obtained mixture undergoes a mechanical separation through decanting or filtering, so as to separate the demineralized fatty phase from the aqueous phase.

2. The method according to claim 1, wherein fatty wastes originate from agri-food or cosmetic industries or from restaurants and food-preparing installations, or municipal or industrial wastewater pretreatment facilities such as skimming tanks and degreasers, or from knackeries.

3. The method according to claim 1, wherein fatty wastes are mainly composed of a fatty fraction, an aqueous fraction and a residual fraction, and are processed beforehand so as to only hold the fatty fraction containing at least 90% of organic matter on a dry basis and at most 10% ash on a dry basis.

4. The method according to claim 1, wherein the fatty wastes, water and acid-type reagent are mixed at a temperature comprised between 45 and 130° C.

5. The method according to claim 1, wherein the fatty wastes, water and acid-type reagent are mixed under stirring for homogenizing the mixture.

6. The method according to claim 1, wherein the amount of water mixed with fatty wastes is comprised between 1/10 and ½ of the volume of fatty wastes.

7. The method according to claim 1, wherein the amount of acid-type reagent mixed with fatty wastes is comprised between 0.5 and 10% of the volume of fatty wastes.

8. The method according to claim 1, wherein the acid-type reagent mixed with fatty wastes is composed of at least an acid selected from the group consisting of mineral acids, such as those of the formula HCl, H₃PO₄, HNO₃ or H₂SO₄, and organic acids of which pKa is less than the pH of fatty wastes in an aqueous medium.

9. The method according to claim 1, wherein the fatty wastes are first mixed with between 10 and 30% of the total amount of water to be mixed with fatty wastes, this mixture being homogenized and heated to a temperature comprised between 45 and 130° C., then, the balance of the total amount of water to be mixed with fatty wastes and the acid-type reagent are added simultaneously to said mixture.

10. The method according to claim 1, wherein fatty wastes are mixed with water and the acid-type reagent for a reaction period comprised between 5 minutes and 3 hours with at least intermittent stirring.

11. The method according to claim 1, wherein the mixture obtained following the chemical treatment is heated to undergo the mechanical treatment.

12. The method according to claim 1 wherein the fatty wastes, water and acid-type reagent are mixed at a temperature of between about 50° C. to 90° C.

13. The method according to claim 1, wherein the amount of water mixed with fatty wastes is about ¼ of the volume of fatty wastes.

14. The method according to claim 1, wherein the amount of acid-type reagent mixed with fatty wastes is between about 0.5 and 4% of the volume of fatty wastes.
